(19) United States
(12) Patent Application Publication
(10) Pub. No.: US 2009/0049249 A1
(43) Pub. Date: Feb. 19, 2009

(54) Transparent cache system and method

(75) Inventor: Grant D. Taylor, Richmond Hill (CA)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/839,595

(22) Filed: Aug. 16, 2007

(51) Int. Cl. G06F 12/08

(52) U.S. Cl. 711/135; 711/E12.022

(57) ABSTRACT

A transparent caching system and a method for transparent caching are provided. The system includes a cache for storing, a processor for executing instructions of the cache, and clone handlers that provide a copy of a cached object. A cache key, corresponding uniquely to the cached object, is configured to identify and lookup the cached object. A pluggable expiration handler is configured to authorize the transparent caching system to clean up the cached object, and a cache object helper determines whether information in the cached object is still valid. If a cache hit is received to retrieve the cached object corresponding to the cache key, a copy of the cached object is provided. To determine if the cached object is to be cleaned up, the expiration handler takes into account at least one of a cache hit count, a time since a last cache hit, and an available memory.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

This invention relates to a transparent cache system with pluggable expiration handlers, and particularly to a method and system for the transparent cache system.

Although Eclipse-based applications may be used with caches, there may be performance problems in Eclipse-based applications that use the Eclipse Modeling Framework (EMF). EMF is a powerful modeling framework, allowing one to author a model using Unified Modeling Language (UML) notions, and then generate the Java code to implement the various constructs. However, loading serialized model files is a very time-consuming operation. A file must first be parsed for the given serialization format (XMI, XML, etc). Secondly, EMF model objects must be constructed and configured with the parsed elements. The overhead is substantial for opening and reading the file, plus constructing the resultant EMF objects.

EMF provides a built-in solution to this problem in the form of resource sets. A resource set contains a group of loaded EMF resources. A given file is only loaded once into a given resource set. It is up to the user of the resource set to ensure that the latest contents from the underlying file are reflected in the resource set (files can be unloaded). The problem with this solution is that Eclipse provides many disparate contributions for various purposes. For example, a builder may want to generate output files for a given resource, a validator may want to create markers on the resource, an editor needs to open a resource for modification, etc. It is impossible for all of the various users of the resource to utilize the same resource set due to their unconnected nature. If one global resource set were to be used, then all resources would stay in memory, causing long-term memory leakage.

A second possible solution would be the use of a normal cache. One problem with using a normal cache is that a lot of code would need to be rewritten to be aware of the cache since a common instance of the data would be used by various pieces of code. In fact, there are cases were it would be very undesirable to have the same objects used by different pieces of code. One example is if an editor is opened on a file. The editor needs to have its own copy, since the changes to the model should not be seen by other pieces of code (e.g., until a save is performed).

A third possible solution would be to leverage Java weak references. The Java platform supplies several constructs for holding weak references. The idea of a weak reference is that the garbage collector is allowed to reclaim the object pointed to by a weak reference if no other regular references exist to the given object. The problem with this approach is that the garbage collector does not run in a predictable manner. The garbage collector is implemented by the Java virtual machine (JVM), so the behavior may vary widely. For example, one JVM may call the garbage collector very often. In this case, the cache would be getting rid of objects too quickly resulting in a minimal performance enhancement.

### SUMMARY

A transparent caching system is provided in accordance with an exemplary embodiment. The transparent caching system includes a cache for storing, a processor for executing instructions of the caching system, and clone handlers configured to provide an exact copy of a cached object stored in the cache. A cache key is configured to identify and lookup the cached object, and the cache key corresponds uniquely to the cached object. A pluggable expiration handler is configured to authorize the transparent caching system to clean up the cached object, and a cache object helper is configured to determine whether information in the cached object is still valid. If a cache hit is received to retrieve the cached object corresponding to the cache key, a copy of the cached object is provided by the clone handlers in response to the cache hit, such that the cached object is preserved during the cache hit. Further, to determine if the cached object is to be cleaned up, the pluggable expiration handler takes into account a cache hit count, the time since a last cache hit, and/or an available memory.

A method for providing a transparent caching system is provided. The method includes storing cached objects in a cache, and providing cache keys to uniquely correspond to the cached objects in the cache. The method determines whether information in a cached object is still valid via a pluggable expiration handler configured to authorize the transparent caching system to clean up the cached object. A copy of the cached object is retrieved via clone handlers in response to a cache hit with a corresponding cache key, and the cached object is preserved during the cache hit. The cached object is cleaned up in the cache if it is determined that the cached object is to be cleaned up, and when authorizing clean up of the cached object, the pluggable expiration handler takes into account at least one of a hit count, a time since a last hit, and the available memory.

Additional features and advantages are realized through the techniques described herein. Other embodiments and aspects are described in detail herein and are considered a part of the claimed invention. For a better understanding of exemplary embodiments with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a device that may implement a transparent cache system in accordance with an exemplary embodiment; and

FIG. 2 illustrates a block diagram for a transparent cache system in accordance with the exemplary embodiment.

The detailed description explains an exemplary embodiment of the invention, together with advantages and features, by way of example with reference to the drawings.

### DETAILED DESCRIPTION OF THE EXEMPLARY EMBODIMENT

An exemplary embodiment provides a transparent caching system with pluggable expiration handlers. The term “transparent” in this case means that the caching system can be easily used by existing systems without altering the existing behavior of the existing systems, yielding minimal changes to the code of the existing system. In the exemplary embodiment, the caching system can quickly return the same data that would have been retrieved using a more time consuming approach. Clone handlers are used to store exact copies of the cached objects. When the cache is hit to retrieve the contents for a particular key, a copy of the value is produced ensuring that the cache always has the original contents and that the original behavior (without caching) is preserved. The pluggable expiration handlers allow the caching system to clean up cached objects in a flexible way. For example, an expiration handler may choose to take into consideration hit count and the time since the last hit to determine when the cached object should cleaned up. The caching system may then be fine tuned to balance memory usage versus temporal performance.

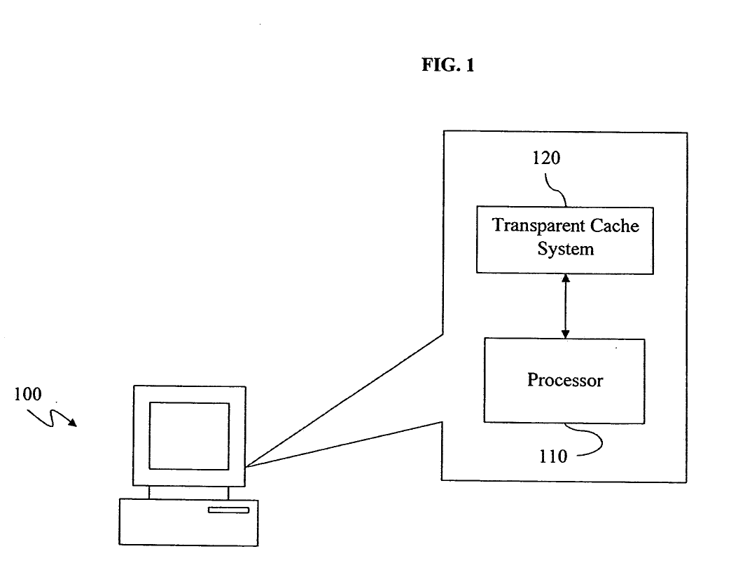

Turning now to the drawings in greater detail, it will be seen that in FIG. 1 illustrates a device that may implement the exemplary embodiment. The exemplary embodiment may be implemented in a device (e.g., general purpose computer) 100 which includes a processor 110 executing computer program code stored on a storage medium [not shown] in order to perform the processes described herein. The device 100 may include or may be operatively coupled to a display screen. The device 100 also comprises a transparent cache system 120. The transparent cache system may be implemented in conjunction with the Eclipse Modeling Framework (EMF). It is understood that other processor-based devices (e.g., servers) may implement the transparent cache system 120 and method described herein.

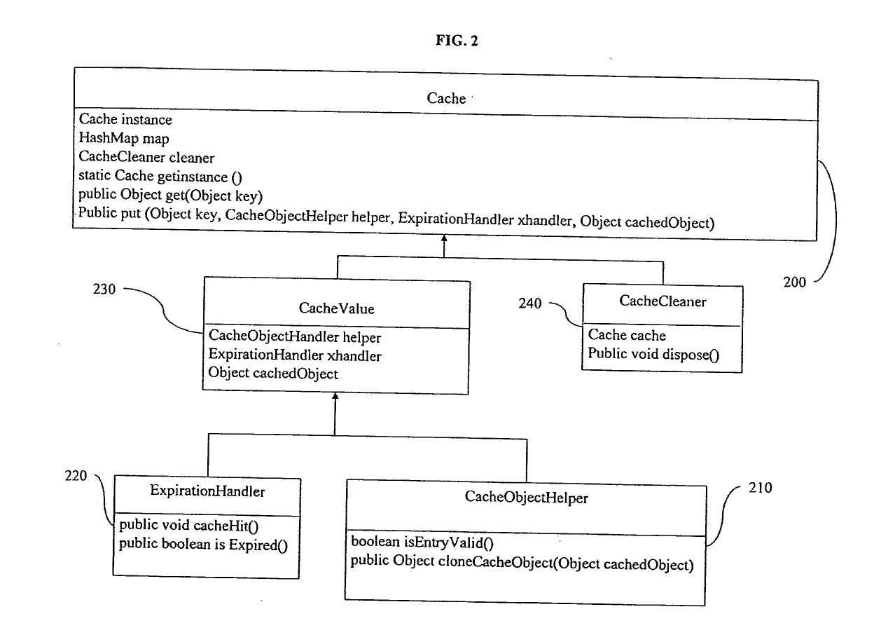

FIG. 2 illustrates a block diagram for a transparent cache system in accordance with the exemplary embodiment. FIG. 2 depicts classes for a unified modeling language (UML) block diagram for explanatory purposes and is not meant to be limiting.

The main class for the transparent caching system 120 may be called “Cache” 200. Although it is understood that a cache may be a type of storage device, for illustrative purposes of understanding the transparent caching system 120, the cache 200 in FIG. 2 may be considered simultaneously as the main class and a type of storage device (e.g., Random Access Memory (RAM)). The main class is a singleton that may comprise two simple methods: put and get. Both the put and get methods are thread-safe since the cache 200 may be accessed simultaneously by multiple threads. When putting objects into the cache, four items may be utilized (1) an object to cache 200, which is stored in the cache 200; (2) a cache key which may be used to identify and lookup cache objects; (3) a CacheObjectHelper 210 which may be used to clone the cached object and determine whether the information in a particular cached object is still valid; and (4) an ExpirationHandler 220 that determines when the cached object can be thrown away.

First, the cache key may be utilized to uniquely identify the cached object in the exemplary embodiment. Different consumers of the cache 200 pass in the same object as the cache key to retrieve the same output. Moreover, the cache key corresponding to the particular cached object stored in the cache 200 provides a means to retrieve the contents of the cached object. As non-limiting examples, the cache key may be a string, a uniform resource locator (URL), or any other object that uniquely identifies the cached object.

Second, the CacheObjectHelper 210 may be utilized to determine if the cached object is still valid and to clone the cached object in the exemplary embodiment. The CacheObjectHelper's 210 isEntryValid( ) method is called when get( ) is invoked on the cache 200 and a match is found. If the isEntryValid( ) call returns false, the item in the cache 200 is discarded, and null is returned. In this non-limiting EMF example, the isEntryValid( ) method may check to see if the cached object (file) still exists and if the last modified time stamp of the cached object has changed since the object was originally cached.

As a non-limiting example, a public class FileURICacheHelper may implement the CacheObjectHelper 210 as follows:

```
{
    protected File fFile;
    protected long fLastModified;
    public FileURICacheHelper(File file)
    {
        super( );
        fFile = file;
        fLastModified = file.lastModified( );
    }
    public boolean isEntryValid( )
    {
        return fFile.exists( ) && fLastModified==fFile.lastModified( );
    }
    public Object cloneCacheObject(Object cachedObject)
    {
        ...cloning logic...
    }
}
```

In the implementation above, the cloneCacheObject( ) method is called immediately when a put( ) is done on the cache 200. The original cached object passed into the put( ) method is cloned, creating a copy in the cache system. For every hit (a successful get( ) call), the cloneCacheObject( ) method is called to create a copy of the cached object.

Following this pattern, the users of the cache 200 are able to modify their copy of the data (in either the put( ) or get( ) scenarios) as they desire, without worrying about corrupting the information in the cache 200. In the non-limiting EMF example, an editor may require its own copy of the data since the data may be modified. Of course, if the editor subsequently saves the modifications to the file (cached object), the isEntryValid( ) method will ensure that the cache 200 will not return stale information.

Additionally, in the exemplary embodiment, separate get( ) methods for reading and writing may be used. As a non-limiting example, if the calling code never intends on modifying the data, then the calling code may call the getOriginal( ) method which would return the actual cached object. If the calling code may modify the object, then the calling code may call the getClone( ) method which would return a clone of the cached object. In the exemplary embodiment, having separate get( ) methods for reading and writing reduces memory consumption and further boosts performance by eliminating the overhead of cloning. However, in some cases, having separate get( ) methods for reading and writing may be weighed against the potential for causing errors since other code has access to the cached object.

Third, the ExpirationHandler 220 may be called to determine when a particular cached object can be cleaned up in the exemplary embodiment. When a cached object in the cache is found on a get( ) call, the cacheHit( ) method on the ExpirationHandler 220 is called, allowing the handler to log the hits as needed. It is up to the ExpirationHandler 220 to calculate whether the cached object should be cleaned up based on the cacheHit( ) information, or some other information that is readily available via the platform on which the caching system is implemented, which may include time since last hit, total time in cache 200, memory usage of program, and available memory of system. Indeed, the ExpirationHandlers 220 may take into account any information received from the transparent cache (e.g., cache 200). The ExpirationHandlers 220 are called periodically for each cached entry via the CacheCleaner 240. As a non-limiting example, a background thread runs and calls the ExpirationHandler 220 for each entry to decide what needs to be cleaned up. This happens automatically and does not require management by other parts of the system using the cache 200. A non-limiting example of an ExpirationHandler 220 would be one that takes hit count and time since last hit into account. Other ExpirationHandlers 220 could take available memory into account, for example.

In the following non-limiting example, a constant-time expiration handler is written. The cached object is only valid for a given period of time, which may be calculated from the time it was put into the cache 200. As a non-limiting example, a public class ConstantExpirationHandler may implement an ExpirationHandler 220 as follows:

```
{
    protected long fStartTime;
    protected long fExpirationTime;
    public ConstantExpirationHandler(long expirationTime)
    {
        super( );
        fStartTime = System.currentTimeMillis( );
        fExpirationTime = expirationTime;
    }
    public void cacheHit( )
    {
    }
    public boolean isExpired( )
    {
        return
        (System.currentTimeMillis( )-fStartTime)>fExpirationTime;
    }
}
```

In addition to the above non-limiting example of an implementation of the ExpirationHandler 220, further adaptability for runtime scenarios may be incorporated, and another feature may be to only expire the cached object after a certain amount of time has passed since the last hit. As a non-limiting example, a public class LastHitExpirationHandler may implement such an ExpirationHandler 220 as follows:

```
{
    protected long fLastHit;
    protected long fExpirationTime;
    public LastHitExpirationHandler(long expirationTime)
    {
        super( );
        fLastHit = System.currentTimeMillis( );
        fExpirationTime = expirationTime;
    }
    public void cacheHit( )
    {
        fLastHit = System.currentTimeMillis( );
    }
    public boolean isExpired( )
    {
        return (System.currentTimeMillis( )-LastHit)>fExpirationTime;
    }
}
```

The previous two non-limiting examples implementing the ExpirationHandler 220 are very straightforward. In the exemplary embodiment, additional ExpirationHandlers 220 may be used which take into account total hits, memory usage, time saved by caching, etc. By using various pieces of information, the cache system could dynamically change its behavior based on the state of the environment.

Fourth, the object to be cached is passed into the put( ) method. Internally, the cache system 120 takes the second, third, and forth parameters passed into the put( ) method and places them into a CacheValue 230 object. Hence, all values in the cache's 200 hash map are objects of this type, which affords the cache 200 the ability to determine if a cached object is still valid or has expired.

Fifth, the CacheCleaner 240 object may be used to ensure that the cache does not grow without bound. The CacheCleaner 240 runs periodically on a separate thread. When running, the CacheCleaner 240 goes through each entry in the cache 200 and calls the corresponding ExpirationHandler 220 to determine if the entry should be discarded. The cached object creates the CacheCleaner 240 with itself as a parameter and starts the CacheCleaner 240 in a new thread. The CacheCleaner 240 continues to run until the cache 200 calls dispose( ).

In accordance with the exemplary embodiment, a non-limiting example using an EMF is provided below which illustrates how the transparent cache system may improve performance. In the non-limiting example, consider an editor that wishes to open a file, and assume that the cache is unpopulated. In the non-limiting example, the following operations occur: the editor is launched with a file path as input; EMF is called to load the model; EMF looks up the file path with a cache key in the cache by calling get( ); no result found (null returned), so EMF loads the model from the file and calls put( ) on the cache system once completed; the cache system calls cloneCacheObject( ) on the CacheObjectHelper so that the cache system has a copy of the model (e.g., cache) objects; and the editor takes the model objects returned by EMF and makes any modifications that it wishes.

In the operations above, having the EMF load the model from the file may be a time consuming operation. Also, the cache has a private copy of the model objects from the file. Further, in the non-limiting example, assume that the user has saved the editor contents, causing the file to change. As a result of the change, other pieces of code are notified that the file has been modified, namely a validator and a builder. In the exemplary embodiment, consider that the validator runs first as follows: EMF is called to load the file; EMF looks up the file path as a key in the cache by calling get( ); the cache finds the entry; the cache calls the isEntryValid( ) method on the CacheObjectHelper, which returns false since the file has changed; the cache cleans up the entry and returns null; no result found (null returned), so EMF loads the model from the file and calls put( ) on the cache system once completed; the cache system calls cloneCacheObject( ) on the CacheObjectHelper so that cache system has a copy of the model objects; and the validator analyzes the model objects as deemed necessary.

Although it may seem that the operations of the non-limiting example may cause the model load operation to be marginally longer, consider that, however, the builder will run next: EMF is called to load the file; EMF looks up the file path as a key in the cache by calling get( ); the cache finds the entry; the cache calls the isEntryValid( ) method on the CacheObjectHelper, which returns true since the file has not changed; the cache calls the cloneCacheObject( ) method on the CacheObjectHelper and returns this object; result found, so EMF simply returns the copied model objects from the cache; and the builder generates other files as deemed necessary.

In the above operations of the non-limiting example, the lengthy process of loading the file is eliminated. Instead, it is replaced by the cloning logic that is very fast. The non-limiting example discussed above with the EMF is now ended.

In accordance with the exemplary embodiment, the caching system 120 described herein provides the features of being transparent and customizable. The EMF example provided illustrations of how the caching system 120 can be effectively used to increase performance with minimal changes to existing code. Furthermore, any software that follows a similar pattern can benefit from the caching system 120. Moreover, since disparate pieces of code need to perform the same time-consuming operations to get a certain piece of data, and the source can be uniquely identified and monitored for validity, the caching system 120 may provide the features discussed herein.

The capabilities of the present invention can be implemented in software, firmware, hardware or some combination thereof.

Although non-limiting examples have been discussed above to illustrate various features, the exemplary embodiment is not meant to be limiting. Also, although certain functions and responsibilities have been designated to certain items, theses designations are for explanatory purposes and are not intended to be limiting.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the exemplary embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A transparent caching system comprising:
a cache for storing;
a processor for executing instructions of the caching system;
clone handlers configured to provide an exact copy of a cached object stored in the cache;
a cache key configured to identify and lookup the cached object, wherein the cache key corresponds uniquely to the cached object;
a cache object helper configured to determine whether information in the cached object is still valid; and
a pluggable expiration handler configured to authorize the transparent caching system to clean up the cached object,
wherein if a cache hit is received to retrieve the cached object corresponding to the cache key, the copy of the cached object is provided by the clone handlers in response to the cache hit, such that the cached object is preserved during the cache hit, and
wherein, to determine if the cached object is to be cleaned up, the pluggable expiration handler takes into account at least one of a cache hit count, a time since a last cache hit, and an available memory.

2. The system of claim 1, wherein separate reading and writing are performed via the processor for the cache, and
wherein if a calling code never intends on modifying the information in the cached object, the calling code calls the actual cached object and not the copy of the cached object provided by the clone handlers, and
wherein if the calling code is to modify the cached object, the calling code calls the copy of the cached object provided by the clone handlers.

3. A method for providing a transparent caching system comprising:
storing cached objects in a cache;
providing cache keys to uniquely correspond to the cached objects in the cache;
determining whether information in a cached object is still valid via a pluggable expiration handler configured to authorize the transparent caching system to clean up the cached object;
retrieving a copy of the cached object, provided by clone handlers, in response to a cache hit with a corresponding cache key, wherein the cached object is preserved during the cache hit; and
cleaning up the cached object in the cache if is determined that the cached object is to be cleaned up, wherein when authorizing clean up of the cached object, the pluggable expiration handler takes into account at least one of a cache hit count, a time since a last cache hit, and an available memory.

4. The method of claim 3, further comprising performing separate reading and writing for the cache,
wherein if a calling code never intends on modifying the cached object, the calling code calls the actual cached object and not the copy of the cached object provided by the clone handlers, and
wherein if the calling code is to modify the cached object, the calling code calls the copy of the cached object provided by the clone handlers.

5. The method of claim 1, wherein the method for providing a transparent caching system is tangibly embodied on a computer readable medium including instructions for causing a computer to execute the method for providing the transparent caching system.
